(19) United States
(12) Patent Application Publication
(10) Pub. No.: US 2025/0074019 A1
(43) Pub. Date: Mar. 6, 2025

(54) BLOW FORMING TOOLING ASSEMBLIES AND METHODS OF USING

(71) Applicant: Joyson Safety Systems Acquisition LLC, Auburn Hills, MI (US)

(72) Inventors: Jeremy Henck, White Lake, MI (US); Mario Najera, Matamoras (MX)

(21) Appl. No.: 18/821,404

(22) Filed: Aug. 30, 2024

Related U.S. Application Data
(60) Provisional application No. 63/535,900, filed on Aug. 31, 2023.

(51) Int. Cl. B29C 70/44

(52) U.S. Cl. CPC B29C 70/44

(57) ABSTRACT

A blow forming tooling assembly includes a first tooling portion and a second tooling portion. The first tooling portion defines a gas intake orifice and a pressure chamber and is operatively coupled to a pressurized gas source for providing pressurized gas to the pressure chamber. The second tooling portion defines a part forming cavity. The first tooling portion and the second tooling portion are coupled together and a membrane is disposed therebetween. A method of using the blow forming tooling assembly for manufacturing composite material articles is also disclosed, wherein a composite material is placed within the part forming cavity, the pressurized gas compresses the membrane, and a heating element heats the blow forming tooling assembly to cure the composite material into a shape defined by the part forming cavity.

### TECHNICAL FIELD

The present disclosure relates to the manufacturing of composite material articles using, for example, composite plastics and carbon fiber reinforced polymers. In particular, the disclosure relates to tooling assemblies for blow forming composite materials and a method of using the tooling assemblies.

### BACKGROUND

One typical method of forming composite material articles includes using an autoclave. Autoclaves are well known in the industrial arts and typically utilize high pressure and temperature in a controlled, sealed environment. Autoclaves are useful for curing resins or other binding agents while the composite materials are under pressure in or on a mold, the mold being adapted to the shape of a desired, finished article. Unfortunately, forming composite material articles in an autoclave is a relatively slow batch process, limiting high volume production. Additionally, autoclaves are typically very large and expensive machines to build, operate, and maintain.

Another typical method of forming composite material articles includes press forming using a mechanical press, often powered by hydraulic systems. Press forming is also well known in the industrial arts but has disadvantages similar to autoclaves, as discussed above. For example, hydraulic presses are large and very expensive pieces of equipment. Additionally, when used to form composite material articles, press forming is incapable of forming undercuts in the finished article, limiting design options. Press forming also cannot ensure resin, or another binding agent, is distributed throughout the external surface of the finished article, diminishing appearance and producing surface porosity that may make it difficult to paint the finished article for desired aesthetics. Therefore, new methods of forming composite material articles are needed, as well as new tooling for use with such methods.

### SUMMARY

In some implementations, a blow forming tooling assembly comprises a first tooling portion defining a gas intake orifice and a pressure chamber. The blow forming tooling assembly further comprises a second tooling portion defining a part forming cavity. A membrane is disposed between the first tooling portion and the second tooling portion. A pressurized gas source is operatively coupled to the pressure chamber by the gas intake orifice.

In other implementations, a blow forming tooling assembly comprises a first tooling portion defining a gas intake orifice and a pressure chamber. The blow forming tooling assembly further comprises a second tooling portion defining a first portion of a part forming cavity and a third tooling portion defining a second portion of the part forming cavity. The second tooling portion and third tooling portion are coupled together so that the first portion of the part forming cavity and the second portion of the part forming cavity are mated together to form the part forming cavity. A membrane is disposed between the first tooling portion and the second and third tooling portions. A pressurized gas source is operatively coupled to the pressure chamber by the gas intake orifice.

In other implementations, a method of blow forming a composite material article comprises the steps of (a) providing a blow forming tooling assembly comprising a first tooling portion defining an gas intake orifice and a pressure chamber, a second tooling portion defining a part forming cavity, a membrane disposed between the first tooling portion and the second tooling portion, and a pressurized gas source operatively coupled to the pressure chamber by the gas intake orifice; (b) placing a composite material within the part forming cavity; (c) causing the pressurized gas source to provide pressurized gas into the pressure chamber to compress the membrane; (d) continuing to provide pressurized gas into the pressure chamber for a threshold period of time; (e) stopping providing pressurized gas into the pressure chamber after the threshold period of time has elapsed; and (f) removing the composite material from the blow forming tooling assembly.

In other implementations, a method of blow forming a composite material article comprises the steps of (a) providing a blow forming tooling assembly comprising a first tooling portion defining an gas intake orifice and a pressure chamber, a second tooling portion defining a first portion of a part forming cavity, a third tooling portion defining a second portion of the part forming cavity, a membrane disposed between the first tooling portion and the second and third tooling portions, and a pressurized gas source operatively coupled to the pressure chamber by the gas intake orifice, wherein the second tooling portion and third tooling portion are coupled together so that the first portion of the part forming cavity and the second portion of the part forming cavity are mated together to form the part forming cavity; (b) placing a composite material within the part forming cavity; (c) causing the pressurized gas source to provide pressurized gas into the pressure chamber to compress the membrane; (d) continuing to provide pressurized gas into the pressure chamber for a threshold period of time; (e) stopping providing pressurized gas into the pressure chamber after the threshold period of time has elapsed; and (f) removing the composite material from the blow forming tooling assembly.

### BRIEF DESCRIPTION OF THE DRAWINGS

The drawings are merely exemplary to illustrate steps, structure, and features that can be used singularly or in combination with other features. The disclosure should not be limited to the implementations shown. Like reference numerals shown throughout the various implementations represent substantially similar steps, structure, and features.

FIG. 1 is a perspective view of a blow forming tooling assembly according to a first implementation.

FIG. 2A is a perspective view of a first tooling portion of the blow forming tooling assembly of FIG. 1.

FIG. 2B is a perspective view of the first tooling portion of FIG. 2A further comprising a seal groove.

FIG. 3A is a perspective view of a second tooling portion of the blow forming tooling assembly of FIG. 1.

FIG. 3B is a perspective view of the second tooling portion of FIG. 3A further comprising a seal groove.

FIG. 4A is a cross-sectional view along the line A-A of the blow forming tooling assembly of FIG. 1 having a planar membrane.

FIG. 4B is a cross-sectional view of the blow forming tooling assembly of FIG. 4A during operation of a method using the blow forming tooling assembly.

FIG. 5A is a cross-sectional view of a second implementation of the blow forming tooling assembly having a preformed membrane.

FIG. 5B is a perspective view of the preformed membrane of FIG. 5A.

FIG. 6A is a cross-sectional view of a third implementation of the blow forming tooling assembly having a single-use, thermal plastic film membrane.

FIG. 6B is a cross-sectional view of the blow forming tooling assembly of FIG. 6A during operation of a method using the blow forming tooling assembly.

FIG. 7A is a perspective view of a fourth implementation of the blow forming tooling assembly.

FIG. 7B is a perspective view of a second tooling portion and a third tooling portion according to the blow forming tooling assembly of FIG. 7A in a coupled state.

FIG. 8A is a flow chart of methods steps for producing a composite material article using the blow forming tooling assembly of the first through third implementations.

FIG. 8B is a flow chart of methods steps for producing a composite material article using the blow forming tooling assembly of the fourth implementation.

FIG. 9A is a side view of a plurality of blow forming tooling assemblies of FIG. 1 on a moving surface.

FIG. 9B is a top-down view of a plurality of blow forming tooling assemblies of FIG. 1 on a rotating surface.

FIG. 10 is a perspective view of a composite material article produced using the blow forming tooling assemblies and methods disclosed herein.

### DETAILED DESCRIPTION

The present disclosure relates to the manufacturing of composite material articles. The devices, assemblies, and methods disclosed herein provide for a tooling assembly for blow forming composite materials and a series of method steps for using the tooling assemblies to form the composite material articles. Typical manufacturing processes for forming composite material articles, using machinery such as autoclaves and hydraulic presses, require too much time and expense, among other concerns. By using the blow forming tooling assemblies and methods disclosed herein, cycle times, costs, and equipment size can all be reduced.

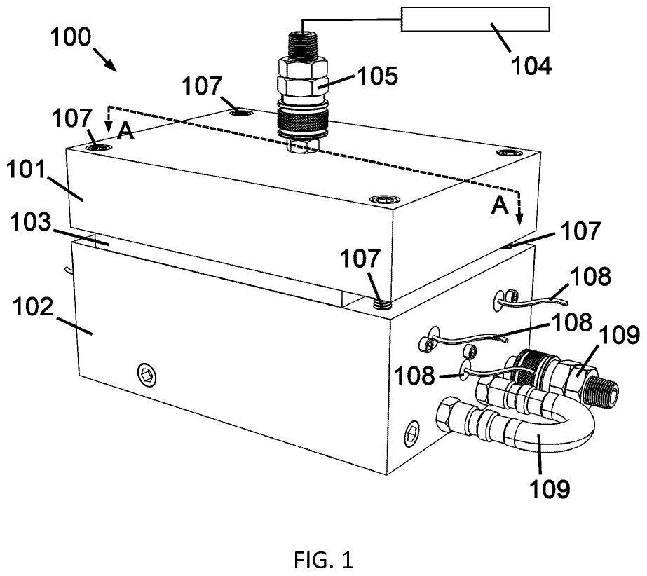

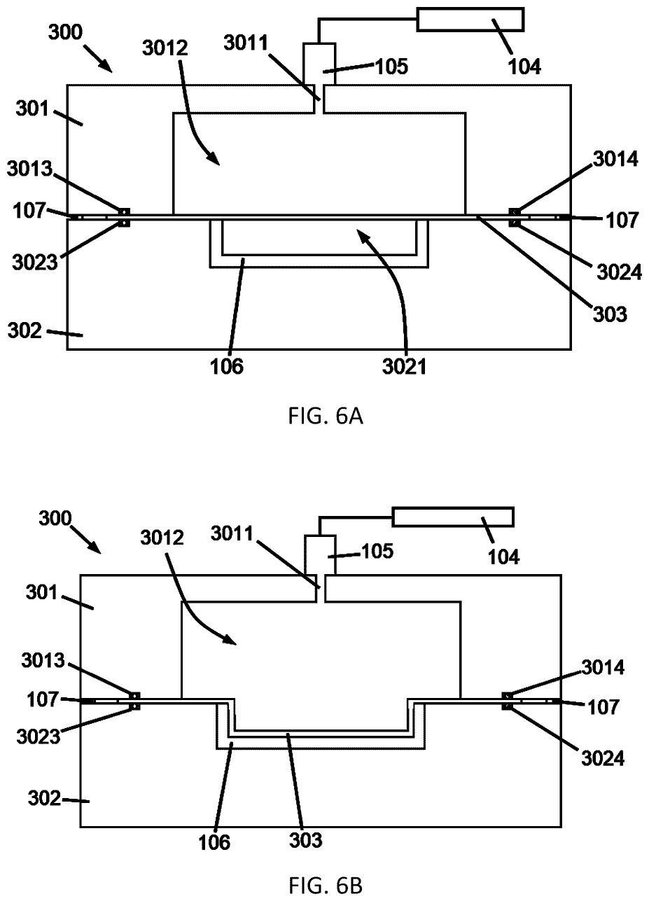

As shown in FIG. 1, one implementation of a blow forming tooling assembly 100 comprises a first tooling portion 101 and a second tooling portion 102. The first tooling portion 101 and the second tooling portion 102 are coupled together using at least one fastener 107. In some implementations, the fastener 107 may be a threaded bolt, as shown for example in FIG. 1. In other implementations, the fastener 107 may be an adhesive, as shown for example in FIGS. 6A-6B. Returning to FIG. 1, a membrane 103 (discussed below) is disposed between the first tooling portion 101 and the second tooling portion 102. A pressurized gas source 104 is operatively coupled to the first tooling portion 101 via a valve 105. In some implementations, the pressurized gas source 104 may be compressed air or other gas. In other implementations, the pressurized gas source may be a pyrotechnic gas generator.

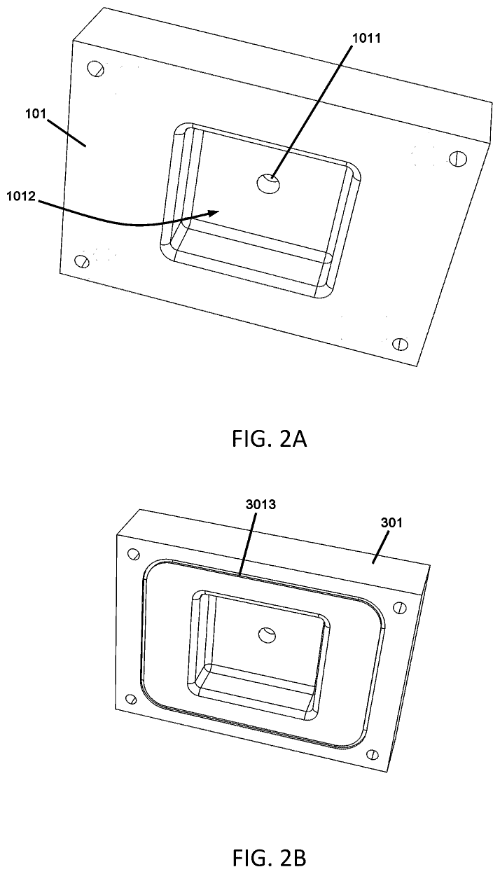

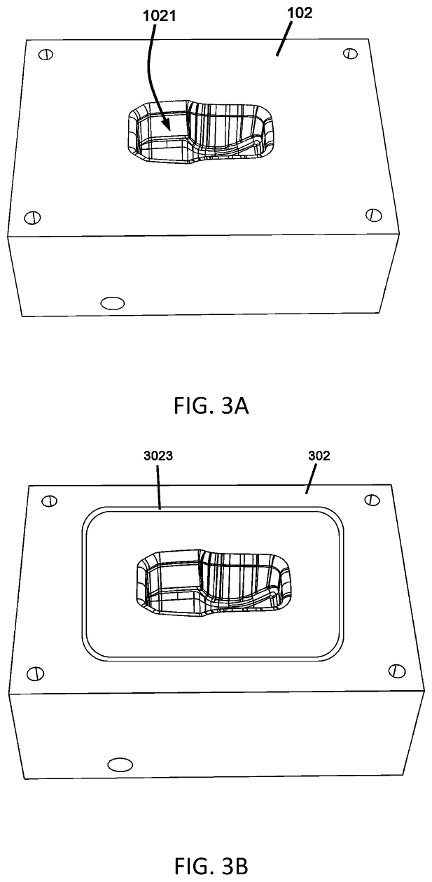

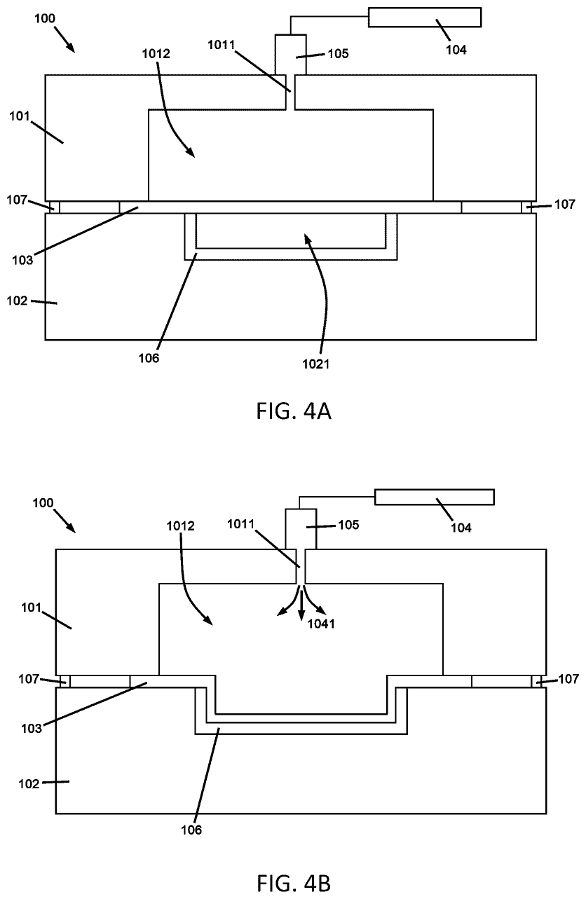

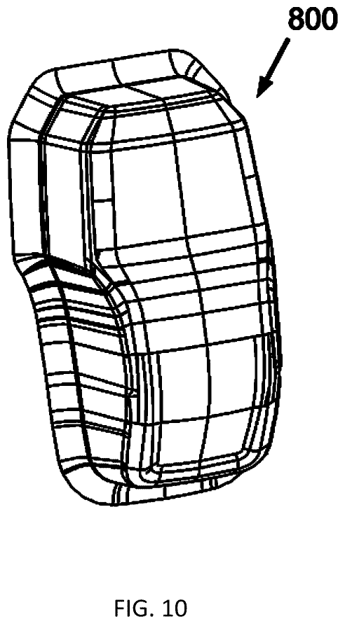

The first tooling portion 101 defines a gas intake orifice 1011 and a pressure chamber 1012, as shown for example in FIG. 2A. The pressurized gas source 104 is operatively coupled to the pressure chamber 1012 via the valve 105 which is coupled to the gas intake orifice 1011. This allows pressurized gas 1041 (e.g., as shown in FIG. 4B) to flow from the pressurized gas source 104 into the pressure chamber 1012. As shown in FIG. 3A, the second tooling portion 102 defines a part forming cavity 1021. The part forming cavity 1021 can be formed in any desired shape so that the finished composite material article is suitable for its intended use. By way of nonlimiting example, the part forming cavity 1021 can be shaped to form a shift knob 800, as shown in FIG. 10, for use in an automobile. In other implementations, other shapes can be used to form different composite material articles.

The membrane 103 may be a polymer pad. In some implementations, the membrane 103 is made of silicone and is reusable. The membrane 103 compresses upon pressurization of the pressure chamber 1012 and presses up against a composite material 106 that is disposed within the part forming cavity 1021. The composite material 106 may comprise carbon fiber (e.g., weave, unidirectional, chopped, or colored) and a curable resin, for example. In other implementations, the composite material may be a composite plastic material, such as KEVLAR, fiberglass (e.g., weave, unidirectional, or chopped), and flaxseed. The membrane 103 also acts as a seal between the first tooling portion 101 and the second tooling portion 102. So long as the perimeter of the membrane 103 is larger than and circumscribes the perimeters of the openings to the pressure chamber 1012 and the part forming cavity 1021, and so long as at least a portion of the membrane is pinched or clamped around its entire perimeter between the first tooling portion 101 and the second tooling portion 102, a seal will be maintained and no pressurized gas 1041 will be lost from the pressure chamber 1012.

Referring to FIGS. 4A-4B, the blow forming tooling assembly 100 is shown in both a pre-operation state (FIG. 4A) and a state during operation (FIG. 4B). Pressurized gas 1041 is introduced into the pressure chamber 1012 via the pressurized gas source 104. The pressurized gas 1041 will compress the membrane 103, in this implementation a planar polymer pad, and push it up against the composite material 106 located in the part forming cavity 1021. Therefore, the composite material 106 is compressed and pushed up against the walls of the part forming cavity 1021, thereby molding to the shape of the part forming cavity 1021. Detailed process steps will be discussed below in further detail.

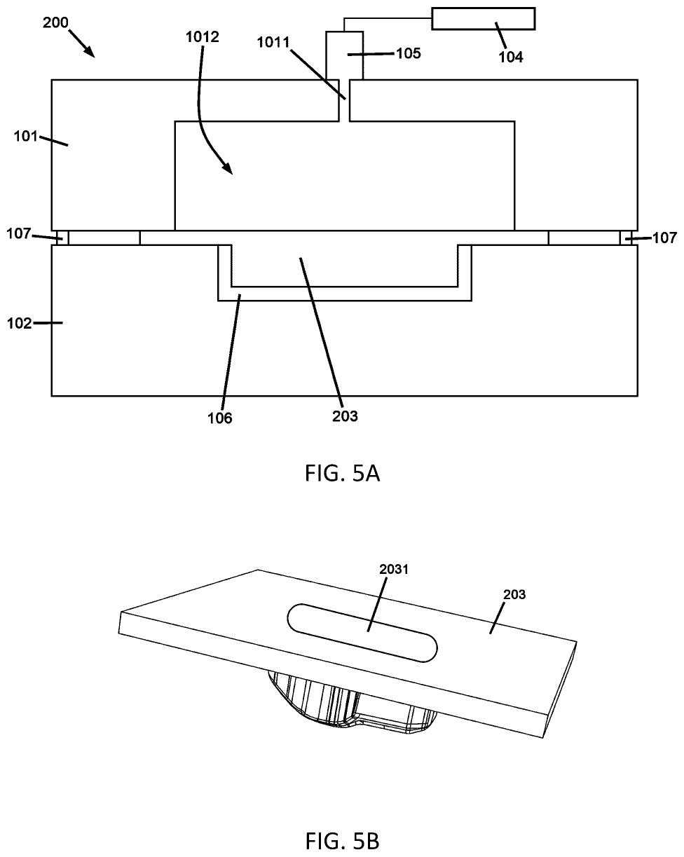

A second implementation of a blow forming tooling assembly 200 is shown in FIGS. 5A-5B. In this implementation, a portion of the membrane 203 is at least partially disposed within the part forming cavity 1021 and preformed to the shape of the part forming cavity 1021 such that there is minimal to no space between the membrane 203 and the composite material 106 at the beginning of operation. Once pressurized gas 1041 is introduced into the pressure chamber 1012, it will compress the membrane 203 and otherwise function similar to the blow forming tooling assembly 100. A cavity 2031 may be formed in the membrane 203 to ensure even pressure across the composite material 106.

A third implementation of a blow forming tooling assembly 300 is shown in FIGS. 2B, 3B, and 6A-6B. In this implementation, the membrane 303 is a single-use, thermal plastic film. For example, the membrane 303 may comprise high-density polyethylene (HDPE), high molecular weight polyethylene (HMWPE), acrylonitrile butadiene styrene (ABS), polycarbonate, polyvinyl chloride, polypropylene, thermoplastic olefin (TPO), high-impact polystyrene (HIPS), acrylic, polyetherimide, polyethylene terephthalate glycol (PETG), and polyethylene terephthalate (PET). To ensure a good seal, in this implementation a first tooling portion 301 and a second tooling portion 302 define seal grooves 3013 and 3023, respectively, around the perimeters of the openings to the pressure chamber 3012 and the part forming cavity 3021. O-rings 3014 and 3024 are inserted into the seal grooves 3013 and 3023, respectively, and provide a seal when the first tooling portion 301 and second tooling portion 302 are coupled together. In other implementations, only one of the tooling portions will define a seal groove and have an o-ring. During operation, the blow forming tooling assembly 300 performs much the same way as described above, whereby pressurized gas 1041 will compress the membrane 303 and push it against the composite material 106, thereby molding the composite material 106 to the shape of the part forming cavity 3021.

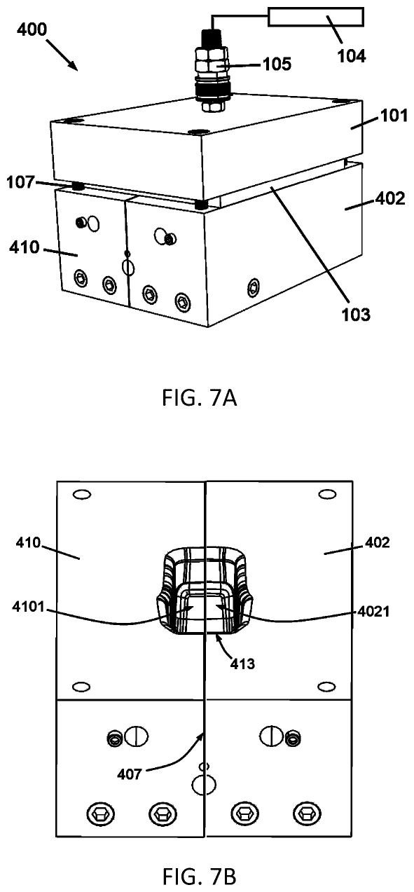

A fourth implementation of a blow forming tooling assembly 400 is shown in FIGS. 7A-7B. Here, the blow forming tooling assembly 400 can be designed similar to, and operate similar to, the previous implementations. However, the blow forming tooling assembly 400 includes a second tooling portion 402 and a third tooling portion 410 that together form the part forming cavity 413. The second tooling portion 402 defines a first portion of the part forming cavity 4021 and the third tooling portion 410 defines a second portion of the part forming cavity 4101. The second tooling portion 402 and third tooling portion 410 may be coupled together by a fastener 407, for example a threaded bolt or, as shown in FIG. 7B, an adhesive disposed in between the second tooling portion 402 and the third tooling portion 410. When coupled together, the first portion of the part forming cavity 4021 and the second portion of the part forming cavity 4101 are mated together to form the part forming cavity 413.

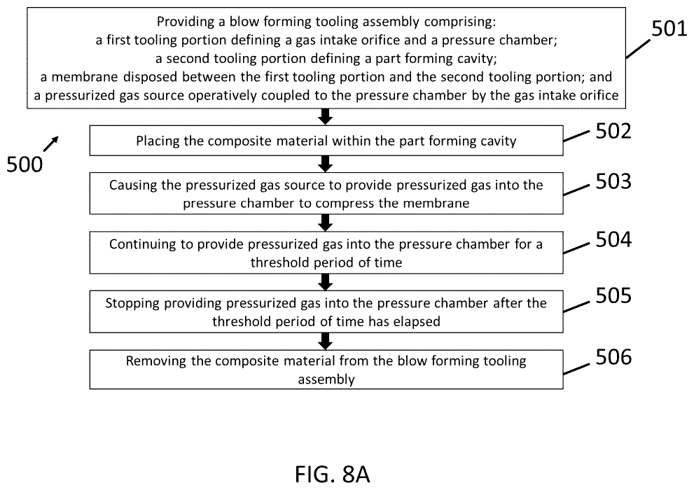

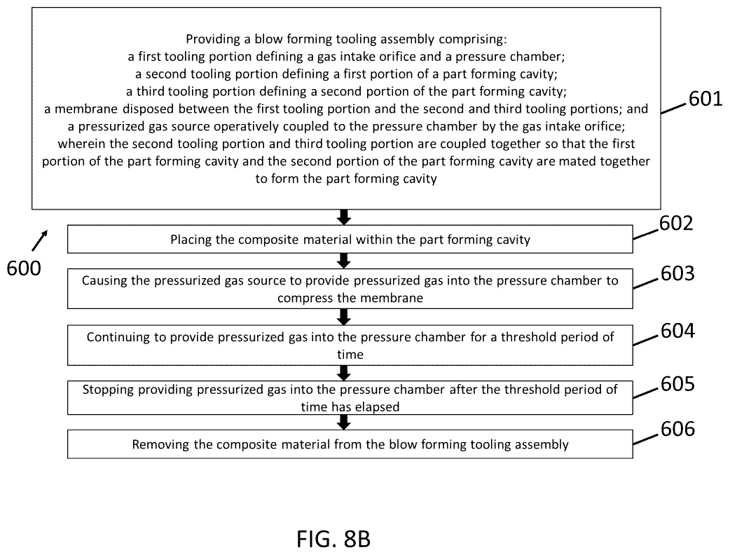

Referring now to the method of using the blow forming tooling assemblies disclosed herein, FIG. 8A shows a method 500 for blow forming a composite material article 800 using any of the blow forming tooling assemblies 100, 200, or 300. For simplicity, the following discussion will be made with reference to the blow forming tooling assembly 100 but is similarly applicable to the blow forming tooling assemblies 200 and 300. Additionally, the method 500 may be utilized with other blow forming tooling assemblies. At step 501, a blow forming tooling assembly 100 is provided comprising a first tooling portion 101 defining a gas intake orifice 1011 and a pressure chamber 1012, a second tooling portion 102 defining a part forming cavity 1021, a membrane 103 disposed between the first tooling portion 101 and the second tooling portion 102, and a pressurized gas source 104 operatively coupled to the pressure chamber 1012 by the gas intake orifice 1011. At step 502, a composite material 106 is placed within the part forming cavity 1021. At step 503, the pressurized gas source 104 provides pressurized gas 1041 to the pressure chamber 1012 to compress the membrane 103. At step 504, pressurized gas 1041 continues to be provided for a threshold period of time. At step 505, after the threshold period of time has elapsed, the pressurized gas source 104 stops providing pressurized gas 1041 to the pressure chamber 1012. Finally, at step 506, the composite material 106 is removed from the blow forming tooling assembly 100.

In some implementations of the method 500, the pressurized gas source 104 provides the pressurized gas 104 into the pressure chamber 1012 to pressurize the pressure chamber 1012 to a pressure of at least 1000 kPa. In some implementations, the pressure is at least 1100 kPa. In some implementations, the threshold period of time is at least 18 minutes. In some implementations, the threshold period of time is at least 20 minutes. Any of these parameters are adjustable based on a variety of factors, including the choice of composite material 106 and the ultimate use for the composite material article 800.

In some implementations, additional steps of heating and subsequently cooling the blow forming tooling assembly 100 can be performed. As shown in FIG. 1, at least one heating element 108 and at least one cooling element 109 can be included. In some implementations, the heating element 108 may be an electrical resistance heater and may be inserted into openings in the second tooling portion 102. The heating element 108 may be electrically coupled to a controller that causes an electrical signal to be sent through the heating element 108, thus producing heat and heating the second tooling portion 102. The cooling element 109 may be a fluid-based cooling system, such as a water-based cooling system, whereby fluid at a lower temperature than the second tooling portion 102 is passed through openings in the second tooling portion 102 and back out again, thereby absorbing heat and carrying such heat to a heat sink outside the second tooling portion 102.

Including a heating step may be advantageous when the composite material 106 comprises a curable resin. By heating the resin under pressure, the resin can flow throughout the composite material 106 and fill all the interstitial space within the composite material 106, as well as being pushed to the surface of the entire composite material 106, ensuring a smooth and consistent appearance of the final composite material article 800. In some implementations, the heating element 108 may heat the second tooling portion 102 to a temperature of at least 130 degrees Celsius during the threshold period of time. In some implementations, the temperature may be at least 160 degrees Celsius. Including a cooling step helps to ensure safe handling of the blow forming tooling assembly and helps to lock in the final shape of the composite material article 800. In some implementations, the cooling element 109 may cool the second tooling portion 102 to a temperature of at most 50 degrees Celsius during the threshold period of time (i.e., before removing the composite material 106). In some implementations, the temperature may be at most 30 degrees Celsius. Any of these parameters are adjustable based on a variety of factors, including the pressure, threshold time, and choice of composite material 106.

Referring now to FIG. 8B, a method 600 for blow forming a composite material article 800 using the blow forming tooling assembly 400 is disclosed. In some implementations, the method 600 may be utilized with other blow forming tooling assemblies. At step 601, a blow forming tooling assembly 400 is provided comprising a first tooling portion 101 defining a gas intake orifice 1011 and a pressure chamber 1012, a second tooling portion 402 defining a first portion of a part forming cavity 4021, a third tooling portion 410 defining a second portion of the part forming cavity 4101, a membrane 103 disposed between the first tooling portion 101 and the second and third tooling portions 402 and 410, and a pressurized gas source 104 operatively coupled to the pressure chamber 1012 by the gas intake orifice 1011, wherein the second tooling portion 402 and third tooling portion 410 are coupled together so that the first portion of the part forming cavity 4021 and the second portion of the part forming cavity 4101 are mated together to form the part forming cavity 413. At step 602, a composite material 106 is placed within the part forming cavity 413. At step 603, the pressurized gas source 104 provides pressurized gas 1041 to the pressure chamber 1012 to compress the membrane 103. At step 604, pressurized gas 1041 continues to be provided for a threshold period of time. At step 605, after the threshold period of time has elapsed, the pressurized gas source 104 stops providing pressurized gas 1041 to the pressure chamber 1012. Finally, at step 606, the composite material 106 is removed from the blow forming tooling assembly 400. The additional heating and cooling steps discussed above may also be applicable to method 600.

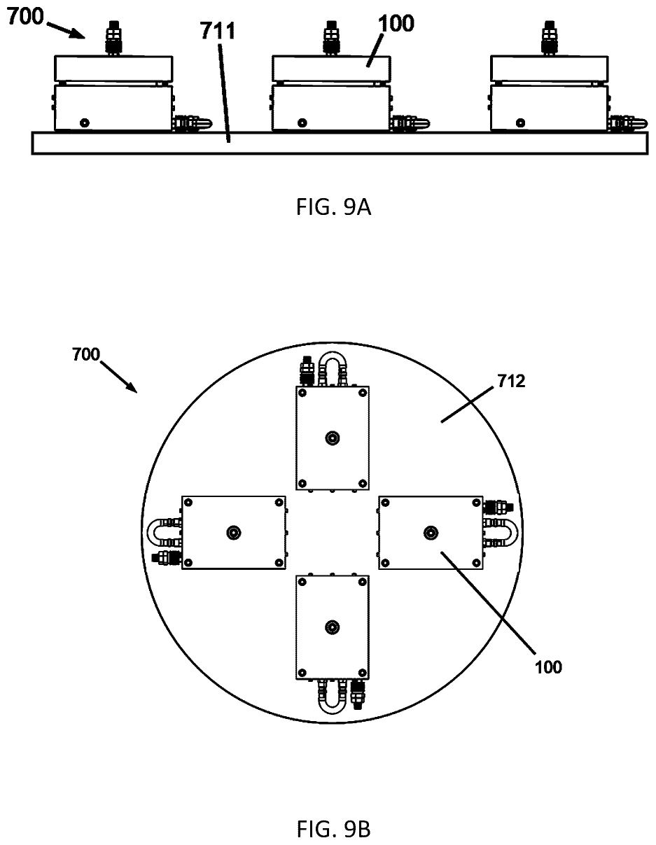

To maximize production capacity, a plurality of blow forming tooling assemblies 100, 200, 300, and/or 400 may be installed together on a moving surface 711, as shown in FIG. 9A (using the blow forming tooling assembly 100). The moving surface 711, such as a linear conveyor belt, may be timed to coordinate with the threshold period of time discussed above, so that an operator can unload and reload each blow forming tooling assembly 100, 200, 300, and/or 400 at set intervals. This way, a composite material article 800 may be finished every few minutes, for example, as compared to a large autoclave which may make a single part over 20 minutes or more and consume more manufacturing floor space. Such a method can be especially useful on a rotating surface 712, as shown in FIG. 9B, such as a circular table rotating in place. For example, if the threshold period of time is 20 minutes, each of the four blow forming tooling assemblies 100 shown in FIG. 9B can be loaded sequentially every 5 minutes as the rotating surface 712 rotates. After the first blow forming tooling assembly 100 has reached the threshold period of time of 20 minutes (i.e., one full rotation), each blow forming tooling assembly 100 can be unloaded and reloaded every 5 minutes thereafter. Optimal production rates can be acquired by modifying the number of blow forming tooling assemblies 100 and the threshold period of time. Since each blow forming tooling assembly 100 has its own pressurized gas source 104, many of the drawbacks of autoclaves and hydraulic presses can be avoided, allowing higher production rates at lower cost.

A number of implementations have been described. The description in the present disclosure has been presented for purposes of illustration but is not intended to be exhaustive of, or limited to, the implementations disclosed. It will be understood that various modifications, variations, and combinations will be apparent to those of ordinary skill in the art and may be made without departing from the spirit and scope of the claims. Accordingly, other implementations are within the scope of the following claims. The implementations described were chosen in order to best explain the principles of the blow forming tooling assembly and its use, and to enable others of ordinary skill in the art to understand how it may be used for various implementations with various modifications as are suited to the particular use contemplated.

1. A blow forming tooling assembly comprising:
a first tooling portion defining a gas intake orifice and a pressure chamber;
a second tooling portion defining a part forming cavity;
a membrane disposed between the first tooling portion and the second tooling portion; and
a pressurized gas source operatively coupled to the pressure chamber by the gas intake orifice.

2. The blow forming tooling assembly of claim 1, further comprising a heating element.

3. The blow forming tooling assembly of claim 2, further comprising a cooling element.

4. The blow forming tooling assembly of claim 1, wherein the first tooling portion and the second tooling portion are coupled to each other.

5. The blow forming tooling assembly of claim 4, wherein the first tooling portion and the second tooling portion are coupled to each other using at least one fastener.

6. The blow forming tooling assembly of claim 1, wherein the membrane is a polymer pad.

7. The blow forming tooling assembly of claim 1, wherein a portion of the membrane is at least partially disposed within the part forming cavity, wherein said portion is preformed to conform to a shape of the part forming cavity.

8. The blow forming tooling assembly of claim 1, wherein the first tooling portion comprises a seal groove, wherein a seal is disposed within the seal groove.

9. The blow forming tooling assembly of claim 8, wherein the membrane is a single-use, thermal plastic film.

10. The blow forming tooling assembly of claim 8, wherein the seal groove is a first seal groove and the seal is a first seal, wherein the second tooling portion comprises a second seal groove, wherein a second seal is disposed within the second seal groove.

11. A blow forming tooling assembly comprising:
a first tooling portion defining a gas intake orifice and a pressure chamber;
a second tooling portion defining a first portion of a part forming cavity;
a third tooling portion defining a second portion of the part forming cavity;
a membrane disposed between the first tooling portion and the second and third tooling portions; and
a pressurized gas source operatively coupled to the pressure chamber by the gas intake orifice;
wherein the second tooling portion and the third tooling portion are coupled together so that the first portion of the part forming cavity and the second portion of the part forming cavity are mated together to form the part forming cavity.

12. The blow forming tooling assembly of claim 11, further comprising a heating element.

13. The blow forming tooling assembly of claim 12, further comprising a cooling element.

14. The blow forming tooling assembly of claim 11, wherein the first tooling portion is coupled to the second tooling portion and the third tooling portion.

15. The blow forming tooling assembly of claim 14, wherein the first tooling portion is coupled to the second tooling portion and the third tooling portion using at least one fastener.

16. The blow forming tooling assembly of claim 11, where in the membrane is a polymer pad.

17. The blow forming tooling assembly of claim 11, wherein a portion of the membrane is at least partially disposed within the part forming cavity, wherein said portion is preformed to conform to a shape of the part forming cavity.

18. The blow forming tooling assembly of claim 11, wherein the first tooling portion comprises a seal groove, wherein a seal is disposed within the seal groove.

19. The blow forming tooling assembly of claim 18, wherein the membrane is a single-use, thermal plastic film.

20. The blow forming tooling assembly of claim 18, wherein the seal groove is a first seal groove and the seal is a first seal, wherein the second tooling portion comprises a second seal groove and the third tooling portion comprises a third seal groove, wherein a second seal is disposed within the second seal groove and the third seal groove.

21-42. (canceled)
